(19) United States
(12) Patent Application Publication
(10) Pub. No.: US 2006/0047913 A1
(43) Pub. Date: Mar. 2, 2006

(54) Data prediction for address generation interlock resolution

(75) Inventors: Linda M. Bigelow, San Antonio, TX (US); Richard E. Bohn, Andover, MN (US); Brian R. Prasky, Wappingers Falls, NY (US); Charles E. Vitu, Santa Clara, CA (US)

Correspondence Address: Lynn L. Augspurger;IBM Corporation, 2455 South Road, P386, Poughkeepsie, NY, 12601, US

(73) Assignee: International Business Machines Corporation, Armonk, NY (US)

(21) Appl. No.: 10/926,478

(22) Filed: Aug. 26, 2004

(51) Int. Cl. G06F 12/00

(52) U.S. Cl. 711/137

(57) ABSTRACT

A method providing a microprocessor with the ability to predict data cache content based on the instruction address of an instruction which is accessing the data cache allows the reduction of address generation interlocking scenarios with the ability to self-correct should the data cache content prediction be incorrect. Content prediction accuracy is kept high through the use of multiple filters. One filter allows predictions to be only used in scenarios where address generation interlock scenarios are present. A second filter allows predictions to be made only when patterns are detected which suggest a prediction will be correct. The third and final filter further improves prediction coverage by detecting patterns of correct potential predictions and utilizing them in the future when they would otherwise be ignored by the basic prediction mechanism.

### CROSS-REFERENCE TO RELATED APPLICATIONS

This application contains subject matter which is related to the subject matter of the following co-pending application which is assigned to IBM, the same assignee as this application, International Business Machines Corporation of Armonk, N.Y. The below listed application is hereby incorporated herein by reference in its entirety:

U.S. patent application Ser. No. ______ (POU920040088) filed concurrently herewith, entitled “Address Generation Interlock Resolution Under Runahead Execution” by Brian R Prasky, Linda Bigelow, Richard Bohn and Charles E. Vitu.

### TRADEMARKS

IBM® is a registered trademark of International Business Machines Corporation, Armonk, N.Y., U.S.A.

### BACKGROUND OF THE INVENTION

1. Field of the Invention

This invention relates to computer processing systems, and particularly to predicting data cache content based on the instruction's address in a computer processing system.

2. Description of Background

A microprocessor having a basic pipeline microarchitecture processes one instruction at a time. The basic dataflow for an instruction follows the steps of: decode, address generation, cache access, register read/cache output, execute, and write back. Each stage within a pipeline occurs in order and hence a given stage can not progress until the stage in front of it is progressing. In order to achieve highest performance one instruction will enter the pipeline every cycle. Whenever the pipeline has to be delayed or flushed, this adds latency which in turn negatively impacts performance with which a microprocessor carries out a task. While there are many complexities that can be added on, the above sets the groundwork for data prediction.

A current trend in microprocessor design has been to increase the number of pipeline stages in a processor. By increasing the number of stages within a pipeline, the amount of logic performed in each stage of the pipeline is reduced. This facilitates higher clock frequencies and most often allows the processor's throughput to increase over a given time frame. With increasing pipeline depth, bottlenecks remain that inhibit translating higher clock frequencies into higher performance. One such bottleneck is that of address generation interlock (AGI). AGI occurs when an instruction produces a result at one segment within the pipeline which is consumed to compute an address at an earlier stage within the pipeline for a following instruction. This requires the consuming address to stall until the producing instruction completes storing its value in one of the processor's registers. Traditional approaches to solving this problem have included providing bypass paths in the pipeline to allow use of produced data as early as possible. This has its limits, and deepening pipelines will increase the number of cycles until the earliest time the data is available in the pipeline. The problem remains of how to remove the remaining stalls created in the pipeline that adversely affect performance.

One method which enables a processor to bypass many stalls is speculative execution through value prediction. Value prediction utilizes value locality, or the tendency for some instructions to produce the same value over several consecutive executions of those instructions. By utilizing predicted values, a processor can bypass true data dependencies and let execution move forward speculatively. To maintain the correct architectural state of the processor, any predicted values need to ultimately be verified for correctness. If a value is mispredicted, a recovery mechanism must be deployed to return the processor to a correct architectural state. In many processor implementations, this recovery mechanism can be more costly in terms of processor cycles used than the number of stall cycles sought to be avoided through value prediction. For this reason, the accuracy of a value predictor must be high enough such that utilizing a value predictor doesn't adversely affect processor performance on the whole. Previous suggested implementations of value predictors have either claimed accuracy rates that are too low to achieve performance improvements in a real processor pipeline or have suggested unrealistic hardware implementations to achieve sufficient accuracy.

### SUMMARY OF THE INVENTION

The preferred embodiment of our invention provides additional advantages in a prediction mechanism for a microprocessor which provides the ability to predict the contents that are to be acquired from a data cache based on the instruction address of the instruction which will be performing the data cache access.

As noted above, one penalty within a microprocessor pipeline is that of address generation interlock. This is a stall within a microprocessor where the address generation that is required to access the data cache content, for a given instruction requires the computed value of a prior instruction. This prior value may in itself be a value from a prior data cache access or that of a computed value from an arithmetic operation. In particular to data content prediction, the focus is on the initial stated penalty where the address generation in respect to accessing the data cache is dependent on a prior cache access. The stated mechanism for predicting such values prior to an instruction accessing the data cache is based on the instruction address of an instruction to access the data cache. Filtering mechanisms are applied such that data predictions will be limited to cases where the predictions are highly accurate and such predictions resolve stalls within the pipeline of the microprocessor. Additional filtering mechanisms allow predictions to be made only when data patterns for a given entry are detected which suggest a prediction will be correct and an override when detecting a series of non-related predictions which would have been correct if they would have been allowed. Through the usage of such data prediction algorithms along with a means to undo the implications caused by incorrect predictions, the performance of a microprocessor is improved by removing avoidable stalls from within the pipeline.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates the basic pipeline of a microprocessor.

FIG. 2 illustrates the AGI prediction consumption mechanism.

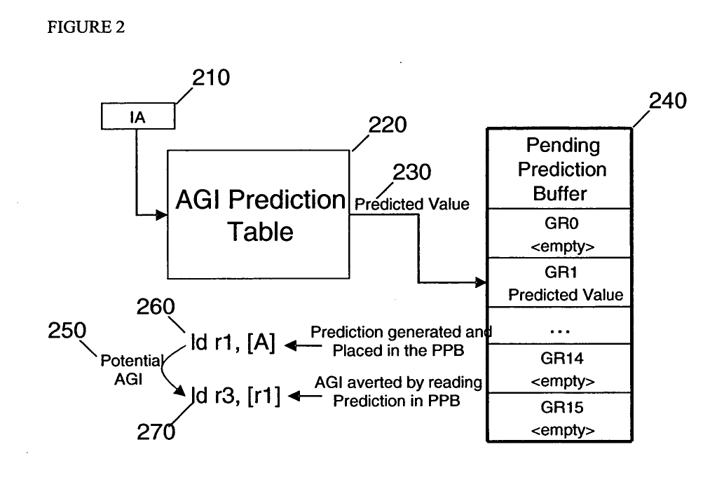

FIG. 3 illustrates the 2-bit state machine which determines if an entry within the data history prediction array is valid.

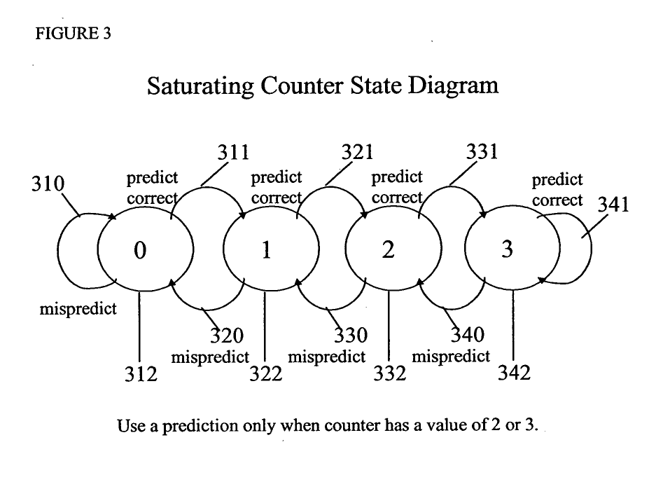

FIG. 4 illustrates the training mechanism for the address data history table.

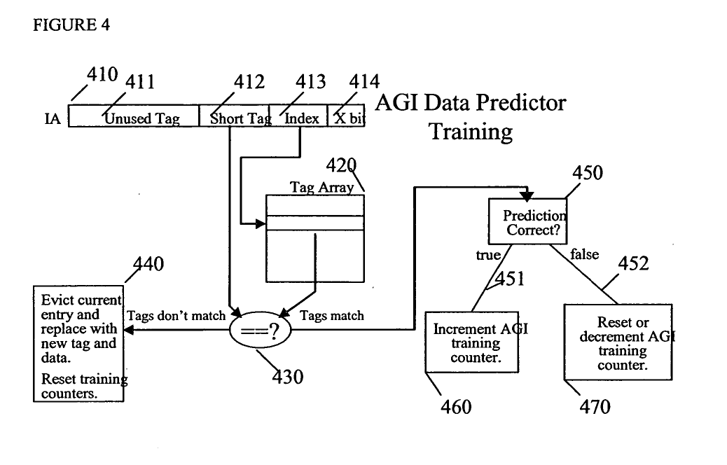

FIG. 5 illustrates the AGI predictor and mechanism for determining if an entry is required to be used.

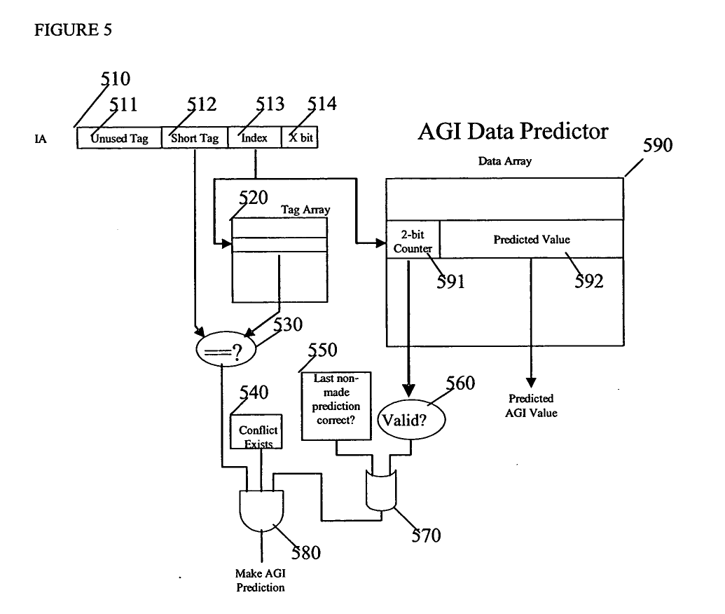

FIG. 6 illustrates the compression mechanism applied to the predicted values.

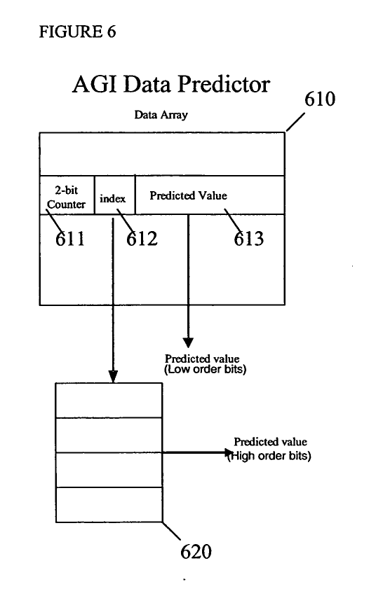

The detailed description explains the preferred embodiments of the invention, together with advantages and features, by way of example with reference to the drawings.

### DETAILED DESCRIPTION OF THE INVENTION

The data predictor described herein stores address generation data inputs 190 with respect to a data cache output 140 in a history table 220, 590, 610 and then uses that stored data 592, 613, 620 to avoid an effect known as address generation interlock. Filtration algorithms 530, 540, 560 are applied to the prediction method to decide when predicted values should and should not be utilized.

The components required to implement the referenced algorithm include the: address data history table 220, 590, 610 with state machine 591, 611 and tag array 420, 520, pending prediction buffer 240, a training mechanism 440 for placing entries into the history table 220, 590, 610 and filters 530, 540, 560 to provide optimal accuracy in respect to data predictions.

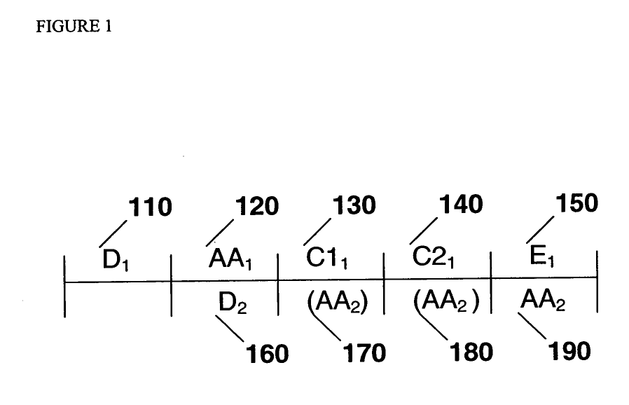

The address data history table 220, 590, 610 for storing data content which is subject to address generation interlock data is indexed by the instruction address (IA) 210, 510. Address generation interlock 250 is an interaction between two instructions where the second instruction 270 is stalled because of a specific dependency on the first instruction 260. Given a 5-stage pipeline, for example, where the instruction is first decoded 110 and in the second stage an address is computed 120 to index the data cache. In the third cycle the data cache is accessed 130 and the output is available in the fourth cycle 140. Fixed point calculations take place in the fifth cycle 150 along with writing the results back to storage. If a second instruction is decoded 160 behind the first instruction where the address computation 170 is dependent on the first result via either the data cache output 140 or the execution result 150, then the penalty is referred to address generation interlock. In such cases address generation (AA) is delayed 170, 180 to align the address generation/adder cycle 190 up to the time frame the contents are available. In FIG. 1, the address adder 190 is lined such that it is awaiting the contents of the data cache 140 as accessed by the prior instruction. Through the usage of the instruction address 210, 410, 510 as a mechanism for indexing the history table 220, 590, 610, the table can be referenced at the decode time frame 110. Because of the time required to access the data, by allowing the table to be accessed at the decode time frame 110 allows the data prediction to be available in time for the desired AA cycle 170 of the following instruction within the pipeline. By making the data content available by this time frame in the pipeline, creates the ability to completely remove the AGI penalty. The removal of this penalty assumes the prediction is correct. Should the prediction be incorrect, a recovery action is required for the pipeline processed data incorrectly.

In a 64-bit architecture, 64 bits could be stored in each address data history table entry 610; however, it is beneficial to store fewer bits per entry 613 when maximizing the performance advantage per transistor. The method for doing this utilizes the generalization that a set of memory references made in a 64-bit architecture will frequently not be distributed across the complete address space. Rather over a given time frame, the address locations referenced are most likely constrained to some region of the complete 64-bit address range. The high order, or most significant, bits of a value loaded from the cache that is involved in address generation is therefore frequently the same across many predictions. If the table held 512 64-bit entries, it is rational that there will be far fewer than 512 unique values in the high-order 32 bits for each table entry. Instead of storing the redundant high-order bits per each entry within the address history table 613, the high order bits can be stored in a separate structure 620 with far fewer entries. Each line in the address data history table then replaces the high-order bits of the predicated data value with a few bits that act as an index 612 into this much smaller structure. While this causes the predictor to require additional time for producing a value, it will significantly reduce the area required by it. This additional time is rational because of the ability to access the array very early on through the use of the instruction address 210, 510 of issue. An implementation is not limited to blocking out the higher 32-bits of a 64-bit architecture as described above but can block out X-bits where X-bits represents a value greater than 0 and less than the number of architected address bits of the machine.

Writing an entry into the table. An entry is to be written into the data array history table when an instruction stalls 170 the pipeline because of a dependency 140 regarding an earlier instruction accessing the data cache. Regarding the instruction which is accessing the data cache. At the time this instruction is decoded 110, the instruction address 410, 510 of the specified instruction accesses 413, 513 the tag array 420, 520 of the address data history table. In respect to writing a new entry in, it is implied here that the entry is not currently in the table. This is denoted by the tag bits of the tag array 420, 520 entry, a higher portion of the instruction address in respect to the indexing of the tag array, not matching 430, 530 the corresponding address bits of the instruction address 412, 512 which is used to index the table. The complete address is not used 411, 414, 511, 514 for the tag array for the additional bits provide minimal performance advantage for the required area. Upon the instruction, which has accessed the data cache, if it is required to be forwarded in the pipeline to a trailing instruction an AGI 250 scenario which qualifies for future prediction has been defined. Upon defining the first occurrence of this AGI 250 which has stalled the pipeline as a proceeding instruction 270 is requiring the contents of the data cache access by an earlier instruction 260, the data is written into the data array history table. The history 591, 611 is modified as defined below, and the tag array 420, 520 portion is updated for the related instruction address bits of the said instruction which addressed the data cache.

Using table entries for making data predictions thereby overcoming AGI penalties. Once an entry is looked up in the history of the address data table, two filters are applied to improve the overall performance of the predictor. The first filter only allows the prediction to be used when using the given prediction allows the speculation of an address to be calculated within the microprocessor pipeline to prevent a stall from occurring within. If there are 5 sequential instructions: A, B, C, D, E and instruction ‘E’ is dependent on instruction ‘A’, but by the time that instruction ‘E’s address generation needs results from instruction ‘A’, ‘A’ has already generated the results ‘E’ needs. Hence a stall is not present 540 in the pipeline and predicting the data value calculated by “A” for ‘E’ would provide no benefit in improving the performance of the pipeline. If instruction ‘B’ is dependent on instruction ‘A’, and at the time instruction ‘B’s address generation needs the data calculated by ‘A’, ‘A’ has yet to calculate the data, then by predicting the data that ‘A’ is to calculate for ‘B’ would remove a stall caused by a dependency 540 and therefore increase the performance of the pipeline given the prediction was correct.

In addition to the address data history table containing a predicted address 592, 612, 613, it also contains a 2-bit state machine, the second filter 560, 580, which is used to determine if an entry within the table is valid for prediction. This 2-bit state machine is a saturating counter. The first bit within the counter represents the validity of an entry. Whenever an AGI 250 occurrence is detected for the first time within the pipeline, the address of concern is placed in the address data predictor 220, 590, 610 such that this value can be predicted in future iterations of the instruction code thereby predicting data required for address generation. When an entry is placed into the table, it takes on an initial value as defined as ‘1’ 322 for this explanation. Should the next time this AGI 250 be encountered, the data resolution of the AGI conflict will be compared to the value which was predicted via the address data history table. In general, if the prediction 450 is correct 451, then the counter is incremented 460 and if the prediction is incorrect 452, the counter is decremented 470. More specifically, ff the prediction matches 321 that of the calculated address causing the conflict, the state machine will be incremented from ‘1’ 322 to ‘2’ 332. If the prediction was incorrect 320 the state machine will be decremented from ‘1’ 322 to ‘0’ 312. Upon being at state ‘0’ 312 and the prediction is incorrect 310, the state will remain at state ‘0’ 312. If the prediction is correct 311, the state machine will be updated to state ‘1’ 322. Once at state ‘2’ 332, if the prediction is incorrect 330, the state will be decremented to state ‘1’ 322. If correct 331, the state will be incremented to state ‘3’ 342. Like state ‘0’ 312, state ‘3’ 342 is a saturating state. If the prediction is correct 341 when at state ‘3’ 342, the state will remain at state ‘3’ 342. If the prediction is incorrect 340, the state will be decremented to state ‘2’ 332.

A modification to the 2-bit state 591 which defines if an entry is valid for prediction is a state 550 which keeps track of the last prediction that was not made, due to that predictor's counter not being in the valid states 560, and whether or not that prediction would have been correct if it has been made. If the prediction would have been correct had the prediction been made, then a future prediction whose counter 560 is not in a valid prediction state will be overridden 570 such that the prediction is allowed as long 580 as AGI remains present 540 for the prediction of relevance.

When a prediction is generated 230 it is possible that the predicted value may need to be used by several trailing instructions in order to remove all AGI. For this reason, the predicted value is stored in a small structure designated the Pending Prediction Buffer (PPB) 240. The predicted value 230 remains in the PPB 240 until either the leading instruction reaches a point 150 in the pipeline where prediction is no longer needed, or an instruction is processed which writes to the general register for which that value is a prediction. Trailing instructions 160 can then check the PPB 240 to determine if there is a prediction waiting for them. If there is, execution can then continue without an AGI stall 170, 180. It is important that instructions store to the PPB 240 and read from the PPB 240 in the same stage of the pipeline. If the store occurred in an earlier stage than the read, a prediction could be prematurely overwritten by another prediction. The store could happen later in the pipeline, but then instructions in an AGI 250 pair that were back-to-back would still experience one cycle of AGI stall before the predicted value is available to be read. Not limited to the description is to allow the PPB 240 to store more than one prediction per architected register.

Once the predictor chooses to actually use a prediction, the prediction 230 must be verified for correctness. In verifying the predicted data 230, the actual value produced 140 needs to be compared to the value predicted 230. This compare can be done as soon as the actual value of the data is produced 140. Since any AGI dependent instructions 160 trail the instruction 110 producing the consumed prediction in the pipeline, this allows sufficient time in a variety of microprocessor implementations for the compare to complete and start a pipeline flush mechanism for the trailing 160, consuming instructions. The flushing is necessary since any trailing instructions that consumed an incorrect prediction would produce incorrect results. By this flush mechanism, the prediction mechanism does not affect the architectural correctness of the machine since incorrect predictions can be detected and are effectively erased from program execution 150.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method of predicting content of a data cache for a microprocessor comprising the steps of:
employing via use of a data history table in said microprocessor a content prediction mechanism for a code sequence being executed by said processor, and by aid of multiple filtering techniques providing a prediction of content of said data cache by establishing a first predicted data cache content for said code sequence and correcting said predicted data cache content should said first predicted data cache content be incorrect based on the instruction address value of the instruction which will be performing the data cache access.

2. The method as defined in claim 1 wherein in establishing said first predicted data cache content for said code sequence a segment of an instruction address value of a stated instruction accessing said data cache is used to index a history table of data content.

3. The method as defined in claim 2 wherein a history prediction is mapped to each data entry within the data history table while establishing said first predicted data cache content to provide a plurality of predictions in said data history table.

4. The method as defined in claim 3 wherein said predictions are filtered such that predictions are only accepted for microprocessor pipeline scenarios and wherein not using a particular prediction would cause the microprocessor to stall in respect to future operation calculations.

5. The method as defined in claim 4 wherein after said predictions are filtered, said predictions are placed in a pending prediction buffer and allowing multiple predictions to be made over a time frame whereby such predictions in said buffer can prevent the microprocessor pipeline from stalling.

6. The method as defined in claim 5 wherein predictions in said buffer which are incorrect allow the pipeline to be flushed such that improper predictions are not released into storage content for the microprocessor.

7. The method of claim 1 where the data history table is not required to contain the complete instruction address value to be predicted but must present the complete instruction address value to be predicted.

8. The method of claim 2 where a portion of the address associated with a given data prediction is stored as a tag for said instruction address with the stated date prediction, said tag being used to validate that an address which is accessing a given entry of the data history table is an entry which corresponds to the address used for indexing.

9. The method of claim 3 such that when a valid history prediction is mapped, the prediction's valid descriptor is not limited to a single bit but rather that of a state machine, where multiple states can designate valid data content for a given entry within the data history table.

10. The method of claim 7 wherein a data history table contains an index into a smaller secondary data history table for predicting the remainder of the data content to be predicted which is not contained within the primary data history table.

11. The method of claim 9 wherein, a bypass filter is provided and allows the overriding of a non-valid entry to be valid based on a value prediction of a prior prediction which was correct but also designated to be in an invalid state.

12. The method of claim 10 wherein nesting history tables are provided and only limited to the extent of the number of bits that are contained for a complete data prediction.

13. The method of claim 1 wherein a filter is employed for predicting scenarios where address generation interlock scenarios are present.

14. The method according to claim 13 wherein a second filter is employed and allows predictions to be made when patterns are detected which suggest a prediction would be correct.

15. The method according to claim 14 wherein a third filter is employed and detects patters of correct potential predictions and utilizes them when they would otherwise be ignored in said prediction.
